(19) United States
(12) Patent Application Publication
(10) Pub. No.: US 2026/0366587 A1
(43) Pub. Date: Nov. 19, 2026

(54) FRICTION MATERIAL COMPOSITION, FRICTION MATERIAL, AND FRICTION MEMBER

(71) Applicant: Resonac Corporation, Minato-ku, Tokyo (JP)

(72) Inventors: Kenji TAKADA, Minato-ku, Tokyo (JP); Takehiko IKEDA, Minato-ku, Tokyo (JP)

(21) Appl. No.: 19/480,081

(22) PCT Filed: Dec. 11, 2024
(86) PCT No.: PCT/JP2024/043895

§ 371 Date: Oct. 30, 2025

(30) Foreign Application Priority Data
Dec. 20, 2023 (JP) 2023-215214

(51) Int. Cl. F16D 69/02

(52) U.S. Cl. CPC F16D 69/026; F16D 2200/006

(57) ABSTRACT

A friction material composition including a fiber base material containing a cellulose fiber, and an inorganic filler, in which a content of an aramid fiber is 3% by mass or less with respect to a total amount of the fiber base material.

### TECHNICAL FIELD

The present disclosure relates to a friction material composition, a friction material, and a friction member.

### BACKGROUND ART

Automobiles, railway vehicles, various industrial machines, and the like are provided with friction materials for braking thereof, such as disc brake pads or brake linings. Friction materials serve in the role of braking by friction with facing materials such as disc rotors or brake drums.

For example, in order to provide friction materials satisfying both friction characteristics and vibration characteristics, a friction material is disclosed in which the friction material includes a fiber base material, a friction adjustment material, and a binder, the content of at least one copper component selected from copper, a copper alloy, or a copper compound is 5% by mass or less in terms of copper element, and the friction material includes from 2 to 7% by mass of elastic graphite, from 3 to 10% by mass of chromite, and from 3 to 15% by mass of a steel fiber (see, for example, Patent Literature 1).

In order to provide friction material compositions less causing brake vibration during high-temperature braking and less causing low-temperature wear, a friction material composition is disclosed in which the friction material composition includes a binder, an organic filler, an inorganic filler, and a fiber base material, and the friction material composition does not contain copper as an element or contains copper at a content of 0.5% by mass or less, contains from 2 to 5% by mass of a steel fiber having a fiber length of 2500 μm or less, and contains a titanic acid salt of a layered crystal structure (see, for example, Patent Literature 2).

In order to provide friction material compositions capable of suppressing brake vibration in high-temperature braking, a friction material composition is disclosed in which the friction material composition includes a binder, an organic filler, an inorganic filler, and a fiber base material, and the friction material composition does not contain copper as an element or contains copper at a content of 0.5% by mass or less, and contains from 2 to 5% by mass of a steel fiber having a fiber length of 2500 μm or less (see, for example, Patent Literature 3).

In order to provide friction materials capable of suppressing brake vibration in high-temperature braking, a friction material is disclosed which is formed from a friction material composition including from 1 to 4% by weight of cashew dust as an organic friction adjustment material, from 7 to 12% by weight of white mica as an inorganic friction adjustment material, and from 0.5 to 5% by weight of an aluminum particle as an inorganic friction adjustment material (see, for example, Patent Literature 4).

### CITATION LIST

### Patent Literature

Patent Literature 1: Japanese Patent Application Laid-Open (JP-A) No. 2015-093935
Patent Literature 2: JP-A No. 2016-121244
Patent Literature 3: JP-A No. 2019-214731
Patent Literature 4: JP-A No. 2021-017521

### SUMMARY OF INVENTION

### Technical Problem

Aramid fibers are used as the fiber base materials in the friction material compositions and the friction materials described in Patent Literature 1 to Patent Literature 4. Friction materials including many aramid fibers may cause deterioration in friction coefficient, called fade. Aramid fibers are petroleum-derived fibers, have recently caused the problems of an increase in cost, depletion, and the like, and furthermore are desired to be reduced in the amount of use as part of carbon neutralization.

The disclosure has been made in view of the above conventional circumstances, and an object of one aspect of the disclosure is to provide a friction material composition capable of forming a friction material capable of suppressing a fade phenomenon, and a friction material and a friction member with this friction material composition.

### Solution to Problem

Specific solutions for achieving the above object are as follows.
<1> A friction material composition including a fiber base material containing a cellulose fiber, and an inorganic filler, wherein a content of an aramid fiber is 3% by mass or less with respect to a total amount of the fiber base material.
<2> The friction material composition according to <1>, wherein a content of the cellulose fiber is 1% by mass or more with respect to a total amount of the friction material composition.
<3> The friction material composition according to <1> or <2>, wherein the content of the aramid fiber is less than 2% by mass with respect to the total amount of the fiber base material.
<4> The friction material composition according to any one of <1> to <3>, wherein a fiber length of the cellulose fiber is less than 2000 μm.
<5> The friction material composition according to any one of <1> to <4>, wherein a content of the cellulose fiber is 4% by mass or more with respect to a total amount of the friction material composition.
<6> The friction material composition according to any one of <1> to <5>, wherein the inorganic filler contains zirconia.
<7> A friction material formed with the friction material composition according to any one of <1> to <6>.
<8> A friction member including the friction material according to <7>.

### Advantageous Effect of Invention

According to one aspect of the disclosure, a friction material composition capable of forming a friction material capable of suppressing a fade phenomenon, and a friction material and a friction member with this friction material composition are provided.

### DESCRIPTION OF EMBODIMENTS

Hereinafter, an embodiment for carrying out the disclosure is described in detail. It is noted that the disclosure is not limited to the following embodiment. In the following embodiment, each component (also encompassing an elemental step or the like) is not essential unless particularly indicated clearly. The same also applies to any numerical value and its range, and such any numerical value and its range do not restrict the disclosure.

A numerical value range herein represented by “(from) . . . to . . . ” in the disclosure means that numerical values described before and after “to” are encompassed as the lower limit and the upper limit, respectively.

The upper limit value or the lower limit value described with respect to one numerical value range as a numerical value range described stepwise in the disclosure may be replaced with the upper limit value or the lower limit value of other numerical value range described stepwise. The upper limit value or the lower limit value described with respect to a numerical value range as a numerical value range described in the disclosure may be replaced with any value represented in Examples.

Each component in the disclosure may encompass plural kinds of corresponding substances. In a case in which plural kinds of corresponding substances are present in each component in a composition, the content or content of such each component means the total content or content of the plural kinds of corresponding substances, unless particularly noted.

A particle corresponding to each component in the disclosure may encompass plural kinds of particles. In a case in which plural kinds of corresponding particles are present in each component in a composition, the particle size of such each component means the value for a mixture of the plural kinds of corresponding particles present in the composition, unless particularly noted.

The term “layer” in the disclosure encompasses not only a case in which the layer is formed in the whole of a region in which the layer is present, but also a case in which the layer is present in only one portion of the region, in observation of the region.

The average particle size of a particle refers to a 50% (median) diameter (D50) determined from a particle size distribution as a volume distribution, as measured with a laser diffraction/scattering type particle size distribution measurement apparatus. The average particle size can be measured with, for example, LA-920 (manufactured by Horiba Ltd.).

### [Friction Material Composition]

The friction material composition of the disclosure includes a fiber base material containing a cellulose fiber, and an inorganic filler, in which the content of an aramid fiber is 3% by mass or less with respect to the total amount of the fiber base material. The friction material composition of the disclosure may include any other component than the above components.

The friction material composition of the disclosure includes a fiber base material containing a cellulose fiber, in which the content of an aramid fiber is 3% by mass or less with respect to the total amount of the fiber base material. The cellulose fiber is included as an alternative to the aramid fiber, and the amount of use of the aramid fiber is reduced. Thus, a friction material composition capable of forming a friction material capable of suppressing a fade phenomenon is provided.

The friction material composition of the disclosure is reduced in the amount of use of an aramid fiber that is a petroleum-derived fiber, and therefore can contribute to carbon neutralization.

### (Fiber Base Material)

The friction material composition of the disclosure includes a fiber base material containing a cellulose fiber.

The fiber base material is included in order to exert the reinforcement effect in a friction material.

The fiber base material may include any fiber (hereinafter, also referred to as “any other fiber”) other than the cellulose fiber, or does not necessarily include such any other fiber.

The fiber base material may include one, or two or more kinds of such cellulose fibers, or may include one, or two or more kinds of such any other fibers than the cellulose fiber.

Examples of the cellulose fiber include a natural cellulose fiber, a regenerated cellulose fiber, or a pulp pulverized product. The regenerated cellulose fiber is one obtained by chemically dissolving natural cellulose included in wood pulp, cotton, or the like, with a solvent or the like, extracting and spinning cellulose, and again forming this cellulose into a fiber, and known one can be used.

Examples of the regenerated cellulose fiber include a rayon fiber, a lyocell fiber, a cupra fiber, or a polynosic fiber.

The pulp pulverized product is one that is obtained by pulverizing kraft pulp and that is not spun by chemical treatment, and known one can be used. One obtained by pulverizing waste paper pulp can also be used.

The fiber length of the cellulose fiber is not particularly limited, may be 5000 μm or less, or may be less than 2000 μm or may be 1000 μm or less from the viewpoint of dispersion.

The lower limit of the fiber length of the cellulose fiber is not particularly limited, and may be 500 μm or more.

The fiber diameter of the cellulose fiber is not particularly limited, and may be from 5 μm to 100 μm, may be from 10 μm to 50 μm, or may be from 15 μm to 30 μm.

The fiber length of the cellulose fiber refers to a number average fiber length indicating the average value of the length of the cellulose fiber. The fiber length of the cellulose fiber refers to an arithmetic average determined by randomly selecting 50 of such cellulose fibers and measuring the fiber lengths of such cellulose fibers with an electron microscope.

The fiber diameter of the cellulose fiber refers to a number average fiber diameter indicating the average value of the diameter of the cellulose fiber. The fiber diameter of the cellulose fiber refers to an arithmetic average determined by randomly selecting 50 of such cellulose fibers and measuring the fiber diameters of such cellulose fibers with an electron microscope.

In a case in which the cellulose fiber is a regenerated cellulose fiber, the fiber length or the fiber diameter of the cellulose fiber can be regulated by adjusting the concentration of spinning dope and adjusting spinning conditions and the like in production of regenerated cellulose.

The content of the cellulose fiber is preferably 1% by mass or more with respect to the total amount of the friction material composition from the viewpoint of fade suppression. The content is preferably 4% by mass or more from the viewpoint of moldability of the friction material composition (for example, tablet formability).

The content of the cellulose fiber may be 20% by mass or less, may be 15% by mass or less, or may be 10% by mass or less with respect to the total amount of the friction material composition.

Examples of such any other fiber include an inorganic fiber, a metal fiber, an organic fiber other than the cellulose fiber, or a carbon-based fiber.

Examples of the inorganic fiber include a ceramic fiber, a biodegradable ceramic fiber, a mineral fiber, a glass fiber, a potassium titanate fiber, a silicate fiber, or wollastonite.

The carbon-based fiber mentioned here can be a flameproof fiber, a pitch-based carbon fiber, a PAN (polyacrylonitrile)-based carbon fiber, an activated carbon fiber, or the like.

The mineral fiber mentioned here refers to blast furnace slag such as slag wool, basalt rock such as a basalt fiber, or an artificial inorganic fiber melted and spun with any other natural rock or the like as a main component. The mineral fiber is preferably a natural mineral-derived fiber containing an Al element. Specific examples include SiO₂, Al₂O₃, CaO, MgO, FeO, and Na₂O, and preferably, one containing an Al element, among them, can be preferably used as the mineral fiber.

The mineral fiber is preferably biosoluble. The biosoluble mineral fiber mentioned here is a mineral fiber that has the characteristic of being partially decomposed and eliminated from the body within a predetermined time even in the case of being taken into the human body. Specifically, the biosoluble mineral fiber represents a fiber in which the total content of alkali metal oxides and alkaline earth metal oxides (the total content of oxides of sodium, potassium, calcium, magnesium, and barium) is 18% by mass or more in terms of the chemical composition and which satisfies a mass half-time of 40 days or shorter for a fiber of 20 μm or more in a short-term bio-persistence test by respiration, no evidence of excessive carcinogenicity in the intraperitoneal test, or no associated pathogenicity and tumorigenesis in the long term respiration test (Nota Q of the EU Directive 97/69/EC (exclusions to carcinogen classification)). Examples of such a biosoluble mineral fiber include a SiO₂—Al₂O₃—CaO—MgO—FeO—Na₂O-based fiber, and include a fiber containing any combination of SiO₂, Al₂O₃, CaO, MgO, FeO, Na₂O, and the like. Examples of a commercially available product include Roxul series manufactured by LAPINUS FIBERS B.V. “Roxul” includes SiO₂, Al₂O₃, CaO, MgO, FeO, Na₂O, and the like.

The metal fiber used here can be a copper or copper alloy fiber in order to enhance cracking resistance and wear resistance.

The copper or copper alloy fiber used here can be a copper fiber, a brass fiber, a bronze fiber, or the like.

The metal fiber used here may also be any metal fiber other than the copper and the copper alloy. Such any metal fiber other than the copper and the copper alloy may be contained from the viewpoints of an enhancement in friction coefficient, and cracking resistance.

Examples of such any metal fiber other than the copper and the copper alloy include a fiber in the form of a single metal or an alloy, such as aluminum, iron, zinc, tin, titanium, nickel, magnesium, or silicone, or a fiber containing a metal as a main component, such as a cast iron fiber.

Examples of the organic fiber include an aramid fiber, an acrylic fiber, or a phenol resin fiber optionally having a crosslinked structure.

The friction material composition of the disclosure may include an aramid fiber or may not necessarily include an aramid fiber as the fiber base material.

The content of the aramid fiber in the friction material composition of the disclosure may be 3% by mass or less with respect to the total amount of the fiber base material, and is preferably less than 2% by mass, more preferably 1.5% by mass or less, still more preferably 1.0% by mass or less, particularly preferably 0% by mass from the viewpoint of enabling a friction material capable of suppressing a fade phenomenon to be suitably formed.

The content of the fiber base material is preferably from 5% by mass to 40% by mass, more preferably from 5% by mass to 30% by mass, still more preferably from 6% by mass to 20% by mass with respect to the total amount of the friction material composition.

The content of the cellulose fiber in the fiber base material may be from 10% by mass to 100% by mass, may be from 15% by mass to 80% by mass, or may be from 20% by mass to 60% by mass with respect to the total amount of the fiber base material.

### (Inorganic Filler)

The friction material composition of the disclosure includes an inorganic filler.

The inorganic filler may be used singly, or in combination of two or more kinds thereof.

Examples of the inorganic filler include graphite, zirconia (zirconium dioxide), metal sulfite, mice, a titanic acid salt, coke, calcium hydroxide (lime hydrate), calcium oxide, sodium carbonate, calcium carbonate, magnesium carbonate, barium sulfate, dolomite, iron oxide, vermiculite, calcium sulfate, talc, clay, zeolite, zirconium silicate, mullite, chromite, titanium oxide, magnesium oxide, silica, iron oxide, garnet, alumina such as α-alumina or γ-alumina, or silicon carbide.

Examples of the graphite include artificial graphite such as petroleum pitch-based or coal pitch-based graphite, or natural graphite.

Examples of the metal sulfide include antimony trisulfide, tin sulfide, tin disulfide, molybdenum disulfide, iron sulfide, iron disulfide, bismuth sulfide, zinc sulfide, or tungsten disulfide.

Examples of the titanic acid salt include potassium titanate, lithium potassium titanate, sodium titanate, or magnesium potassium titanate.

The inorganic filler may contain at least one selected from the group consisting of graphite, zirconia, metal sulfide, a titanic acid salt, barium sulfate, calcium hydroxide, and alumina.

The content of the inorganic filler may be from 30% by mass to 85% by mass, may be from 50% by mass to 80% by mass, or may be from 60% by mass to 80% by mass with respect to the total amount of the friction material composition.

The inorganic filler may contain zirconia.

The content of the zirconia is preferably 40% by mass or less, more preferably from 10% by mass to 35% by mass, still more preferably from 15% by mass to 30% by mass with respect to the total amount of the friction material composition.

The mass ratio between the zirconia and the cellulose fiber (zirconia:cellulose fiber) may be from 25:1 to 25:15, or may be from 25:2 to 25:10.

The average particle size of the zirconia is preferably from 1 μm to 10 μm, more preferably from 1 μm to 5 μm.

The inorganic filler may contain a titanic acid salt (preferably, potassium titanate).

The content of the titanic acid salt (preferably, potassium titanate) is preferably from 40% by mass or less, more preferably from 10% by mass to 35% by mass, still more preferably from 15% by mass to 30% by mass with respect to the total amount of the friction material composition.

The mass ratio between the titanic acid salt (preferably, potassium titanate) and the cellulose fiber (titanic acid salt:cellulose fiber) may be from 26:1 to 26:15, or may be from 26:2 to 26:10.

The inorganic filler may contain barium sulfate.

The content of the barium sulfate is preferably from 20% by mass or less, more preferably from 5% by mass to 15% by mass, still more preferably from 5% by mass to 12% by mass with respect to the total amount of the friction material composition.

The mass ratio between the barium sulfate and the cellulose fiber (barium sulfate:cellulose fiber) may be from 10:0.5 to 10:15, or may be from 10:1 to 10:10.

### (Organic Filler)

The friction material composition of the disclosure may include an organic filler.

Examples of the organic filler include friction dust or cashew dust.

The organic filler may be used singly, or in combination of two or more kinds thereof.

The content of the organic filler may be from 4% by mass to 20% by mass, may be from 5% by mass to 15% by mass, or may be from 6% by mass to 10% by mass with respect to the total amount of the friction material composition.

### (Binder)

The friction material composition of the disclosure may include a binder.

The binder is to bind and integrate the components included in the friction material composition, thereby imparting a predetermined shape and strength. The binder included in the friction material composition of the disclosure is not particularly limited, and a known thermosetting resin used as a binder for friction materials can be used.

Examples of the thermosetting resin include a phenol resin (resol-type phenol resin or novolac-type phenol resin), an epoxy resin, or a polyimide resin. Examples thereof also further include various modified phenol resins such as an acryl-modified phenol resin, a silicone-modified phenol resin, a cashew-modified phenol resin, an epoxy-modified phenol resin, and an alkylbenzene-modified phenol resin. These can be used singly, or in combination of two or more kinds thereof. In particular, at least one selected from the group consisting of a phenol resin, an acryl-modified phenol resin, a silicone-modified phenol resin, and an alkylbenzene-modified phenol resin is preferably used because it imparts favorable heat resistance, moldability, and friction coefficient.

The content of the binder is preferably from 4% by mass to 20% by mass, more preferably from 5% by mass to 15% by mass, still more preferably from 6% by mass to 10% by mass with respect to the total amount of the friction material composition. The content of the binder is in a range of from 4% by mass to 20% by mass with respect to the total amount of the friction material composition, whereby deterioration in strength of the friction material can be more suppressed.

### (Any Other Material)

The friction material composition of the disclosure may include, if necessary, any other material than the above components.

Examples of such any other material include a fluoropolymer such as PTFE (polytetrafluoroethylene), or a rubber powder.

Such any other material may be used singly, or in combination of two or more kinds thereof.

Examples of the rubber component included in the rubber powder include tire rubber, natural rubber, acrylonitrile-butadiene rubber (NBR), acrylic rubber, isoprene rubber, polybutadiene rubber (BR), styrene-butadiene rubber (SBR), or silicone rubber. The rubber powder may also be a tire powder including tire rubber.

The shape of the friction material composition of the disclosure is not particularly limited, and may be a powder shape, a tablet shape, or the like.

### [Friction Material]

The friction material of the disclosure is formed with the friction material composition of the disclosure. The friction material of the disclosure can be used for friction materials such as disc brake pads or brake linings used in automobiles.

The friction material of the disclosure can be produced by molding the friction material composition of the disclosure according to a method commonly used. Preferably, the friction material is produced by heat- and pressure-molding. Specifically, the friction material is produced by mixing the friction material composition of the disclosure by use of a mixing machine such as a Loedige mixer, a pressure kneader, or an Eirich mixer, preliminarily molding this mixture in a mold, molding the preliminarily molded product obtained, by heating in conditions of a molding temperature of from 140 °C to 160 °C and a molding pressure of from 20 MPa to 50 MPa for from 4 minutes to 10 minutes, and heat-treating the molded product obtained, at from 180 °C to 250 °C for from 2 hours to 10 hours. Coating, a scorch treatment, a polishing treatment, or the like is, if necessary, performed.

### [Friction Member]

The friction member of the disclosure includes the friction material of the disclosure. The friction material of the disclosure in the friction member of the disclosure preferably forms a friction surface in the friction member.

Examples of the friction member of the disclosure include the following configurations.
(1) Configuration of only the friction material
(2) Configuration having a back metal and the friction material of the disclosure serving as a friction surface provided on the back metal
(3) Configuration (2) in which a primer layer for the purpose of surface modification for an increase in adhesion effect of the back metal to the friction material and an adhesion layer for the purpose of adhesion of the back metal and the friction material are further interposed between the back metal and the friction material.

### EXAMPLES

Hereinafter, the disclosure is described in further detail with reference to Examples, but the disclosure is not limited to these Examples at all.

### [Production of Disc Brake Pad]

Materials were blended at a blending ratio (% by mass) shown in Table 1, to obtain each friction material composition of Examples and Comparative Example. The unit of the amount of blending of each component in Table 1 is expressed by “% by mass” in the friction material composition. In Table 1, “−” means that the corresponding component is not contained. The details of Cellulose 1 and Cellulose 2 used are as follows.

### —Cellulose 1—

Fiber length: 900 μm, fiber diameter: 20 μm, bulk density: 20 to 40 g/L

### —Cellulose 2—

Fiber length: 2200 μm, fiber diameter: 35 μm, bulk density: 25 to 50 g/L

This friction material composition was mixed in a Loedige mixer (trade name: Loedige mixer M20, manufactured by MATSUBO Corporation), this mixture was preliminarily molded by a molding press (manufactured by Oji Machine Co., Ltd.), the preliminarily molded product obtained was subjected together with a back metal made of iron and steel to heat- and pressure-molding with a molding press (manufactured by SANKI SEIKO CO., LTD.) in conditions of a molding temperature of 150 °C and a molding pressure of from 20 MPa to 40 MPa for 5 minutes, and the molded article obtained was heat-treated at from 200 °C to 300 °C, polished with a rotary polishing machine, and subjected to a scorch treatment, to obtain a disc brake pad (friction material thickness 11 mm, friction material project area 52 cm²).

A general performance test was carried out according to JASO C406. Specifically, a ⅕ scale tester (inertia 3.0 kg·m²) and a test piece of 18 mm×44 mm cut out from the disc brake pad produced in each Example and each Comparative Example were used, and the minimum value (Min. min. μ) of the average friction coefficient μ in the 1'st Fade test, as an index of fade suppression, was determined. The wear on JASO performance in Table 1 means the pad average wear (mm) after completion of the test. The fade suppression in Table 1 means that, as the numerical number is higher, a fade phenomenon is more suppressed.

TABLE 1

| | | Comparative | Example | Example | Example | Example | Example |
|---|---|---|---|---|---|---|---|
| | | Example 1 | 1 | 2 | 3 | 4 | 5 |
| Fiber | Aramid fiber | 3 | 1.5 | — | — | — | — |
| base | Cellulose | — | 1.5 | 3 | 4.5 | 6 | — |
| materials | fiber 1 | | | | | | |
| | Cellulose | — | — | — | — | — | 6 |
| | fiber 2 | | | | | | |
| | Rock wool | 5 | 5 | 5 | 5 | 5 | 5 |
| Binding | Phenol resin | 9 | 9 | 9 | 9 | 9 | 9 |
| agent | | | | | | | |
| Organic | Friction dust | 8 | 8 | 8 | 8 | 8 | 8 |
| filler | | | | | | | |
| Inorganic | Antimony | 2 | 2 | 2 | 2 | 2 | 2 |
| fillers | trisulfide | | | | | | |
| | Graphite | 5 | 5 | 5 | 5 | 5 | 5 |
| | Zirconia | 25 | 25 | 25 | 25 | 25 | 25 |
| | Alumina | 3 | 3 | 3 | 3 | 3 | 3 |
| | Potassium | 26 | 26 | 26 | 26 | 26 | 26 |
| | titanate | | | | | | |
| | Lime hydrate | 4 | 4 | 4 | 4 | 4 | 4 |
| | Barium | 10 | 10 | 10 | 8.5 | 7 | 7 |
| | sulfate | | | | | | |
| Test | Fade | 0.13 | 0.20 | 0.22 | 0.19 | 0.21 | 0.20 |
| results | suppression | | | | | | |
| | (Min. min. μ) | | | | | | |
| | Wear on | 0.9 | 1.0 | 1.1 | 1.0 | 1.1 | 1.0 |
| | JASO | | | | | | |
| | performance | | | | | | |
| | (mm) | | | | | | |

As clear from the evaluation results in Table 1, a fade phenomenon could be suppressed in the brake pad formed with the friction material composition of each of Examples, as compared with the brake pad formed with the friction material composition of Comparative Example.

The disclosure of Japanese Patent Application No. 2023-215214 filed on Dec. 20, 2023 is herein incorporated by reference in its entirety.

All documents, patent applications, and technical standards described herein are herein incorporated by reference, as if each individual document, patent application, and technical standard were specifically and individually indicated to be incorporated by reference.

1. A friction material composition, comprising: a fiber base material comprising a cellulose fiber; and an inorganic filler,
wherein a content of an aramid fiber is 3% by mass or less with respect to a total amount of the fiber base material.

2. The friction material composition according to claim 1, wherein a content of the cellulose fiber is 1% by mass or more with respect to a total amount of the friction material composition.

3. The friction material composition according to claim 1, wherein the content of the aramid fiber is less than 2% by mass with respect to the total amount of the fiber base material.

4. The friction material composition according to claim 1, wherein a fiber length of the cellulose fiber is less than 2000 μm.

5. The friction material composition according to claim 1, wherein a content of the cellulose fiber is 4% by mass or more with respect to a total amount of the friction material composition.

6. The friction material composition according to claim 1, wherein the inorganic filler comprises zirconia.

7. A friction material, formed from the friction material composition according to claim 1.

8. A friction member, comprising the friction material according to claim 7.
